(19) United States
(12) Patent Application Publication
(10) Pub. No.: US 2017/0149309 A1
(43) Pub. Date: May 25, 2017

(54) Electric Machine For High Speeds

(71) Applicant: Siemens Aktiengesellschaft, Muenchen (DE)

(72) Inventors: Anne Bauer, Fuerth (DE); Michael Frank, Uttenreuth (DE); Joern Grundmann, Grossenseebach (DE)

(73) Assignee: Siemens Aktiengesellschaft, Muenchen (DE)

(21) Appl. No.: 15/316,662

(22) PCT Filed: Jun. 8, 2015
(86) PCT No.: PCT/EP2015/062656

§ 371 Date: Dec. 6, 2016

(30) Foreign Application Priority Data
Jun. 10, 2014 (DE) 10 2014 211 029.7

(51) Int. Cl. H02K 9/197; H02K 5/128; H02K 1/26

(52) U.S. Cl. CPC H02K 9/197; H02K 1/26; H02K 5/128

(57) ABSTRACT

An electric machine may include a stator and a rotor that is rotatably mounted about an axis of rotation. The rotor has an internal rotor core provided with at least one electric coil winding. The rotor core and the coil winding are radially enclosed by an external rotor casing, the greater part of the perimeter of which is composed of a soft magnetic material.

### CROSS-REFERENCE TO RELATED APPLICATIONS

This application is a U.S. National Stage Application of International Application No. PCT/EP2015/062656 filed Jun. 8, 2015, which designates the United States of America, and claims priority to DE Application No. 10 2014 211 029.7 filed Jun. 10, 2014, the contents of which are hereby incorporated by reference in their entirety.

### TECHNICAL FIELD

The invention relates to an electric machine with a stator and a rotor that is rotatably mounted about an axis of rotation, wherein the rotor has an internal rotor core which is provided with at least one electric core winding. Specifically, the invention relates to a synchronous machine of this design.

### BACKGROUND

Synchronous machines according to the prior art comprise a fixed stator and a rotor which is arranged for rotation around a stationary axis, wherein the rotor typically carries an excitation winding, which generates the necessary rotating magnetic field for the operation of the machine. The stator has a plurality of electrical coil windings, the combination of which is connected to a single- or multi-phase AC voltage system. The rotating field is thus synchronized to the system frequency. In an “internal-field machine”, the rotor is typically configured as a cylindrical body arranged inside a hollow cylindrical stator. Between the coil windings of the rotor and the stator an air gap is provided which, in order to increase the efficiency of the machine and/or to minimize production and material costs, is generally maintained as small as possible.

A synchronous machine of this type can, in principle, be operated either as a motor or as a generator. In motor operation, electric power is tapped from the grid system and is converted into mechanical power by the rotation of the rotor. To this end, the rotor is appropriately connected to a rotor shaft, which transmits the torque generated. Motors of this type can be used, for example, for the propulsion of compressors, fans or pumps. In generator operation, conversely, mechanical energy is converted into electrical energy, and an externally-induced rotation of the rotor shaft generates an AC voltage in the stator coils, by means of magnetic induction.

In both operating modes, the excitation winding of the rotor receives a direct current flux which is transmitted from an external power system to the rotating coil winding. Synchronous machines are known in which the excitation winding is configured as a superconductive coil winding on the grounds that, given the negligible DC resistance of a coil of this type, an exceptionally high efficiency and/or a compact design is achievable. A superconductive excitation winding of this type is described, for example, in US 2012 0235532 A1 and in EP 490550 B1.

A problem in the manufacture of superconductive excitation windings is posed by the mechanical loading of the sensitive superconductors by the high centrifugal forces. Moreover, in many applications, machines with very high speeds of 3,000 revolutions per minute or more are required. In order to prevent the excessive centrifugal loading of the superconductors and other components, it is therefore desirable that synchronous machines of this type with exceptionally high speed ratings should be configured with as slender a design as possible, and consequently with the smallest possible radial diameter.

Moreover, an electric machine of a given electric power rating is invariably subject to a lower limit on its rational radial diameter which, precisely in the case of superconductive excitation windings, is frequently limited by space requirements for the typically normal-conducting stator windings. For a given current density in these stator windings, which are generally of copper construction, space requirements for the accommodation of the winding cross section, in combination with space requirements for the winding retaining structures, dictate the space required on the inner circumference of the hollow cylindrical stator. In “air-gap windings”, retaining structures are constructed of non-magnetic materials whereas, conversely, in conventional stator windings, core teeth arranged between the windings additionally serve to guide the magnetic flux. At high load capacities, these retaining structures are also required to be able to accommodate large forces and torques, thereby resulting in a certain minimum space requirement on the inner circumference of the stator. A further problem associated with a substantial reduction of the internal diameter is posed by the necessary cooling of the stator windings. If the generation of heat associated with ohmic losses and/or iron losses occurs within a very confined space, complex cooling systems are required which, to some extent, may also for their part require further space on the interior surface of the stator.

A reduction of the internal stator diameter in comparison with conventional dimensions is also problematic on the grounds that, for an equal capacity, the requisite magnetic flux per unit of surface area of the interior of the stator would need to be substantially increased. Higher magnetic flux densities of this type result in larger stray field components. Likewise, a reduction in the induced voltage with a simultaneous increase in current does not represent a satisfactory solution, as current densities in the stator windings are already limited in any event. In general, the offsetting of the reduced internal diameter by an axial elongation of the machine would also have a negative impact upon efficiency, size, weight and costs.

Essentially, in conventional electric machines, the internal diameter of the stator simultaneously also dictates the external diameter of the rotor, as the air gap between the stator windings and the rotor windings must be maintained as small as possible, in order to achieve a high radial component of the magnetic flux at the site of the stator windings. In conventional electric machines, by the combination of the aforementioned marginal conditions, the speed of the rotor is thus subject to an upper limit.

### SUMMARY

One embodiment provides an electric machine with a stator and a rotor that is rotatably mounted about an axis of rotation, wherein the rotor has an internal rotor core which is provided with at least one electric coil winding, and wherein the rotor core and the core winding are radially enclosed by an external rotor casing, at least the greater part of the circumference of which is composed of a soft magnetic material.

In one embodiment, the rotor casing, at least over the greater part of its circumference, has a thickness of at least 1 cm.

In one embodiment, the rotor casing assumes the basic form of a regular cylindrical hollow body, in which the external diameter of the hollow body is at least 10% greater than the internal diameter of the hollow body.

In one embodiment, the electric coil winding of the rotor is configured as a superconductive coil winding.

In one embodiment, the soft magnetic material of the rotor casing has a relative magnetic permeability of at least 30.

In one embodiment, the rotor casing is provided with at least one pair of diametrically opposing recesses.

In one embodiment, the recesses are configured as recesses in the soft magnetic material of the rotor casing, wherein the recesses are at least partially filled with a non-magnetic material.

In one embodiment, the rotor casing is provided with two diametrically opposing arrangements, each comprised of a plurality of axially spaced recesses.

In one embodiment, the rotor casing is provided with at least two diametrically opposing, and respectively radially continuous interruptions.

In one embodiment, the coil winding for the generation of a magnetic field is configured with a pole pair number n, wherein the rotor casing has at least n pairs of respectively diametrically opposing recesses, and wherein said recesses in the circumferential direction are each arranged between adjoining poles.

In one embodiment, an inner gap is arranged between the rotor core, fitted with the electric coil winding, and the rotor casing.

In one embodiment, the rotor casing encloses the rotor core and the electric coil winding in a vacuum-tight manner.

In one embodiment, an inner vacuum chamber is arranged between the rotor core with the electric coil winding and the rotor casing, which encloses the rotor core and the electric coil winding in a vacuum-tight manner.

In one embodiment, the rotor casing is enclosed by an outer vacuum chamber.

In one embodiment, the electric coil winding is secured on the rotor core by at least one fixing strap of a poor thermally-conductive material.

### BRIEF DESCRIPTION OF THE DRAWINGS

Example aspects and embodiments of the invention are described below with reference to the drawings, in which:

FIG. 1 shows a schematic cross section of an electric machine according to a first exemplary embodiment,

FIG. 2 shows a schematic cross section of a rotor casing according to a second exemplary embodiment,

FIG. 3 shows a schematic cross section of a rotor casing according to a third exemplary embodiment,

FIG. 4 shows a schematic longitudinal section of a rotor casing according to a fourth exemplary embodiment,

FIG. 5 shows a schematic longitudinal section of an electric machine according to a fifth exemplary embodiment, and

FIG. 6 shows a schematic longitudinal section of an electric machine according to a sixth exemplary embodiment.

### DETAILED DESCRIPTION

Embodiments of the invention provide an electric machine which eliminates the aforementioned disadvantages. Specifically, an electric machine for very high speeds is to be disclosed.

Some embodiments provide an electric machine including a stator and a rotor that is rotatably mounted about an axis of rotation. The rotor in this case has an internal rotor core which is provided with at least one electric coil winding. The rotor core and the core winding are radially enclosed by an external rotor casing, at least the greater part of the circumference of which is composed of a soft magnetic material.

The electric machine may provide a significant advantage, in that the internal diameter of the stator can be selected to be significantly larger than the external diameter of the internal rotor core and the electric coil winding arranged thereupon. The combination of the rotor core and the electric coil winding is also designated hereinafter as the internal rotor. In this arrangement, the rotor core can, for example, be wound with the coil winding, or the previously wound coil winding can be fitted to the rotor core subsequently. The coil winding can at least partially enclose the rotor core and/or can alternatively be arranged, for example, on radially outer areas of the rotor core.

The radial clearance between the outer surface of the internal rotor and the inner surface of the stator is appropriately occupied, to a greater extent, by the external rotor casing, the function of which is to guide the magnetic excitation field generated by the electric coil winding of the rotor. The smallest possible air gap between the stator and the rotor casing can thus be advantageously achieved. As a result of the presence of the rotor casing, in comparison with conventional electric machines, the external diameter of the internal rotor can be substantially reduced, with no simultaneous requirement for the reduction of the internal diameter of the stator in a similar manner. This permits the operation of the electric machine at higher speeds, as the components of the internal rotor, as a result of the smaller diameter thereof, are subject to smaller centrifugal forces at a comparable speed. Specifically, the mechanical loading of the electric coil winding of the rotor, at comparable speeds, is reduced. Appropriately, the rotor casing is mechanically bonded to the rotor core such that the rotor casing and the rotor core will rotate synchronously, and the connection will withstand mechanical loads, even at high speeds.

In some embodiments, the electric machine may additionally be provided with one or more of the following characteristics:

The rotor casing, over the greater part of its circumference, can have a thickness of at least 1 cm. A thickness of at least 5 cm, and specifically of at least even 20 cm, is particularly advantageous. This embodiment has the advantage that the external diameter of the internal rotor can be selected to be smaller, at least by the above-mentioned thickness value, than the internal diameter of the stator. By a strong diametral dissociation of this type, a machine with a particularly small diameter of the internal rotor can be constructed, which is therefore suitable for particularly high speeds. The aforementioned thickness of the rotor casing is the wall thickness of said casing over the greater part of its circumference. Independently of this nominal wall thickness, the rotor casing, in other subsections, can be provided with a thinner wall thickness. Specifically, in certain subsections, the rotor casing can be provided with recesses and, in said subsections, can either have a significantly thinner wall thickness, or can even incorporate radial through-openings. The rotor casing can assume the basic form of a regular cylindrical hollow body. This shall be understood to include such forms of the rotor casing in which the basic hollow cylindrical form is provided with recesses at various points. The external diameter of the hollow body can be at least 10% greater than the internal diameter of the hollow body. Particularly advantageously, the internal diameter and the external diameter can differ by at least 20%, and specifically can even differ by up to 40%. The advantages of these embodiments are comparable with those of the aforementioned minimum nominal wall thickness values. In a hollow cylindrical rotor casing, the nominal wall thickness is defined as half of the difference between the external and internal diameters.

Appropriately, the overall cylindrical rotor rotates in a likewise cylindrical inner space of the stator, the diameter of which is also designated as the stator bore diameter. Advantageously, only the smallest possible gap is provided here between the rotor casing and the inner surface of the stator, such that the external diameter of the rotor casing and the internal diameter of the stator only differ by a small margin. For example, the width of this gap can range from 1 mm to 100 mm.

The electric coil winding of the rotor can be configured as a superconductive coil winding, specifically of a high-temperature superconductive material. In machines with such a super-conductive excitation winding, particularly high efficiencies and other advantageous properties can be achieved. The choice of a superconductive excitation winding, combined with the aforementioned diametral characteristics of the internal rotor and the stator, is particularly advantageous, as rotor windings of superconductive materials, on the grounds of high conductivity, can be exceptionally compact, and can be fitted to rotors of small diameter. Moreover, in sensitive superconductive materials such as ceramic high-temperature superconductors, it is particularly important to prevent excessive mechanical loading by high centrifugal forces. Electric machines with a superconductive excitation winding can thus be exceptionally advantageously configured for the dissociation of geometrical requirements governing the internal diameter of the stator and the external diameter of the internal rotor by the interposition of a synchronously rotating soft magnetic rotor casing.

The soft magnetic material of the rotor casing can have a relative magnetic permeability of at least 30, and specifically of at least 300. Specifically, the soft magnetic material can comprise iron, cobalt and/or nickel, and alloys of the aforementioned metals. The function of this soft magnetic material of the rotor casing is the amplification of the magnetic field generated by the excitation coil in the vicinity of the stator. Specifically, in the interspace between the internal rotor and the stator, which is substantially occupied by the soft magnetic material, it is intended that a magnetic flux with the largest possible radial component should be generated. To this end, the fullness factor of the radial interspace can advantageously range from 50% to 99%, and particularly advantageously from 70% to 95%.

The rotor casing can advantageously be provided with at least one pair of diametrically opposing recesses. Specifically, such recesses can be configured as recesses in the soft magnetic material of the rotor casing. This embodiment has the advantage that the magnetic flux component which is lost as the magnetic short-circuit between the poles of the magnetic excitation field in the material can be kept as small as possible. By the action of the aforementioned recesses, the magnetic flux induced in the material of the rotor casing has a particularly high radial component, thereby conducting the maximum possible magnetic flux in the direction of the stator. The aforementioned pairs of diametrically opposing recesses are thus particularly appropriate for the restriction of potential short-circuit paths between the magnetic poles, in a paired and consequently as symmetrical arrangement as possible. Viewed over the circumference, an approximately sinusoidal field characteristic is thus advantageously generated in the air gap and/or at the site of the stator.

The aforementioned recesses can be configured as recesses in the soft magnetic material of the rotor casing, wherein the recesses can be at least partially filled with a non-magnetic material. Particularly advantageously, the recesses can also essentially be entirely filled with a non-magnetic material. Non-magnetic materials are to be understood here as all materials which are neither ferromagnetic nor ferrimagnetic. Alloys or other material mixtures with relative permeabilities μᵣ below 30 are also to be classified here as non-magnetic. Particularly advantageously, non-magnetic materials with relative permeabilities of less than 10 can be used. Specifically, air can also be used as a non-magnetic infill for the recesses, by means of which a magnetic short-circuit between the poles of the excitation field can be inhibited or reduced. Particularly advantageously, however, the recesses can be at least partially filled with a solid material such that, at these points, the mechanical strength of the rotor casing, entrained in rapid rotation with the rotor, is increased. Appropriate materials for solid non-magnetic infills include, for example, non-magnetic alloys, specifically non-magnetic steel, glass-fiber-reinforced plastic, carbon-fiber-reinforced plastic, titanium and its alloys.

The rotor casing can be provided with at least two diametrically opposing arrangements, each comprised of a plurality of axially spaced recesses. Specifically, two or more such arrangements can be provided, each of which can be configured as a regular grid pattern or else an irregular grid pattern of individual recesses. Between these individual recesses, the full nominal wall thickness of the rotor casing can be provided in places, thereby enhancing, for example, the mechanical stability of the rapidly rotating entrained rotor casing. The rotor casing can be provided with at least two diametrically opposing, and respectively radially continuous interruptions. By this arrangement, magnetic short-circuit paths between the poles can be advantageously depleted. Such radially continuous recesses in a soft magnetic material can particularly advantageously be filled with a non-magnetic material, in order to ensure the mechanical strength of the rotor casing. Alternatively or additionally, the recesses can be configured as axially spaced arrangements of a plurality of individual recesses, between which at least part of the wall thickness of the rotor casing is maintained. The advantageous characteristics of the recesses in the rotor casing described hereinafter can also be mutually combined in various ways.

The coil winding for the generation of the magnetic field can be configured with a pole pair number n, wherein the rotor casing has at least n pairs of respectively diametrically opposing recesses, and wherein said recesses in the circumferential direction are each arranged between two adjoining poles. Two-pole machines are in widespread use, particularly as generators. With a corresponding pole pair number of one, the rotor casing can thus advantageously have at least one pair of diametrically opposing recesses, which are arranged in the circumferential direction between the likewise opposing poles. Particularly advantageously, the recesses can be arranged essentially midway between the respective adjoining poles and thus, in a two-pole machine, equatorially between the poles. In electric machines with a higher pole pair number of two or more, correspondingly higher numbers of pairs of recesses can then be provided, wherein the recesses and poles are advantageously distributed in the circumferential direction such that at least one such recess is always arranged between each two adjoining poles. Specifically, the recesses can each be arranged approximately midway between two adjoining poles in the circumferential direction. The central arrangement between adjoining poles is particularly appropriate for the depletion of direct magnetic short-circuit paths between the magnetic poles, and for the enhancement of the radial components of the magnetic flux in the rotor casing material. In turn, all combinations of the aforementioned configurations of the recesses are possible. Specifically, at each position in the circumferential direction, a series of multiple recesses can be arranged, in a mutually axially spaced arrangement.

An inner gap can be arranged between the rotor core, fitted with the electric coil winding, and the rotor casing. In other words, an inner gap can be arranged between the internal rotor and the rotor casing. This inner gap can appropriately facilitate the fitting of the internal rotor into the rotor casing. Similarly to the external air gap between the rotor casing and the stator, it is appropriate that an inner gap of this type should be kept as small as possible, for example between 0.1 mm and 50 mm, and specifically between 1 mm and 10 mm. The inner gap can be an air gap. Alternatively, however, the inner gap can also be evacuated. Moreover, supporting structures can be arranged in the inner gap, specifically for the minimization of any sag and/or imbalance in axially elongated rotors.

The rotor casing can enclose the rotor core and the electric coil winding in a vacuum-tight manner. This configuration is particularly appropriate where the excitation winding is a superconductive coil winding, which must be cooled to cryogenic temperatures and, in the operation of the machine, the rotor casing simultaneously assumes a far higher temperature, for example room temperature or higher. In the presence of an inner gap between the rotor casing and the internal rotor, the rotor casing can serve to maintain the vacuum in this inner gap, thereby providing the optimum thermal insulation of the internal rotor from the rotor casing. For example, the entire internal rotor can then be cooled down to a temperature close to the service temperature of the superconductor and, in service, the rotor casing can be maintained at a significantly warmer temperature. The mechanical connection between the internal rotor and the rotor casing is then appropriately configured of poor thermally-conductive materials, in order to maintain a temperature difference of this type. In general, the mechanical connection between the internal rotor and the rotor core can be provided at both axial end zones of the rotor. Alternatively or additionally, however, further connections can also be provided in axially more inward-lying regions. As poor thermally-conductive connections of this type, glass-fiber-reinforced plastics or other materials with a thermal conductivity not exceeding 2 W/mk and/or a thermal-conductivity integral not exceeding 20 W/cm can advantageously be used. These advantageous limiting values for thermal conductivity refer specifically to values measured at room temperature.

An inner vacuum chamber can be arranged between the rotor core with the electric coil winding and the rotor casing, which encloses the rotor core and the electric coil winding in a vacuum-tight manner. In this configuration, an additional vacuum-tight partition is thus arranged in the inner gap between the rotor casing and the internal rotor. At least that part of the inner gap which lies between the vacuum chamber and the internal rotor is then evacuated during operation, such that a steep temperature gradient can be maintained between the cold internal rotor and the warm rotor casing. This embodiment is then appropriate if the soft magnetic material of the rotor casing is not sufficiently vacuum-tight to simultaneously fulfill the function of a vacuum chamber. In the embodiment with an additional vacuum chamber in the inner gap, it is also appropriate that at least the internal rotor and the vacuum chamber, in the axial end zones, should be interconnected by means of poor thermally-conductive materials.

Alternatively or additionally, the rotor casing can be enclosed by an outer vacuum chamber. In this configuration, the rotor casing is also appropriately cooled to a temperature close to the service temperature of the superconductor, and the substantial temperature gradient exists between the rotor casing and its vacuum chamber. This vacuum chamber can, for example, rotate with the remaining components of the rotor. In this case, the outer vacuum chamber should be connected to the remaining components by means of poor thermally-conductive materials. Alternatively, the vacuum chamber can be rigidly arranged in the interior of the stator, wherein rotation of the rotor, in the latter case, is permitted by vacuum-tight rotary seals in the vacuum chamber for the rotor shaft. In this embodiment, the mechanical attachment of the rotor casing to the internal rotor does not necessarily need to be formed of poor thermally-conductive materials. The vacuum chamber can advantageously be configured of a poor electrically-conductive material, for example of glass-fiber-reinforced plastic.

In a configuration of this type, in which the rotor casing is also subject to freezing temperatures during the operation of the machine, the rotor casing should be formed of cold-resistant materials. For example, X8Ni9 steel can be selected as the soft magnetic material for the rotor casing.

The aforementioned embodiments for thermal insulation are configured such that the entire internal rotor, including the rotor core, is maintained at a cold temperature level. In conventional electric machines with superconductive excitation windings, a similar thermal configuration is known from DE 10300269 A1, in which the entire rotor is enclosed in a non-magnetic vacuum jacket. For the mounting of the cooled rotor in the warm environment of the electric machine, poor thermally-conducting support and torque transmission elements can generally be used, as described in DE 10110674 A1. In embodiments of this type, the cooling of the internal rotor can be achieved in a particularly advantageous manner by the circulation of a coolant within the rotor shaft, in accordance with the thermosiphon principle.

Alternatively to a thermal configuration of this type, the rotor core can also assume a warm temperature level, and the superconductive excitation windings can be supported on the warm rotor core by poor thermally-conductive support elements, such that the main temperature gradient occurs between the electric coil winding and the rotor core. Support elements of this type are described, for example, in EP 690550 B1 and in US 20120235532.

In some embodiments of the rotor, the electric coil winding can be also be secured on the rotor core by at least one fixing strap of this type, or similar, of a poor thermally-conductive material. A configuration of this type has the advantage that the rotor core assumes a warm temperature level, and consequently does not require thermal insulation from the rotor casing. The mechanical connection between the rotor core and the rotor casing can thus be configured with no consideration of thermal insulating properties. At very high speeds, this can be advantageous as, under these conditions, the mechanical connection between the rotor core and the rotor casing is required to accommodate very high loads. In this case, overall, the best possible thermal insulation between the core winding and the rotor core must then be provided, which can be achieved in a similar manner to that described in the prior art. Advantageously, the at least one electric coil winding can be secured by means of straps of a poor thermally-conductive material, for example straps of glass-fiber-reinforced plastic. The electric coil winding can be arranged on the rotor core in an evacuated and thermally-isolated region.

The soft magnetic material element of the rotor casing can advantageously be configured as a solid body. This permits the simple manufacture of the rotor casing and simultaneously provides high mechanical strength. Moreover, a solid body of this type can simultaneously function as a vacuum chamber. The requisite recesses can then be machined into this solid body which, where applicable, can be filled with a non-magnetic material.

Alternatively, the rotor casing can be formed of an axially-laminated stack of plates of a soft magnetic material. In this embodiment, recesses can be pre-incorporated into the individual plates, which are appropriate for the interruption or depletion of the magnetic short-circuit between the poles of the excitation winding. In a embodiment with a plate stack of this type, in a simple manner, more complex forms of recesses and arrangements with a plurality of individual recesses can also be provided. Specifically, by this arrangement, recesses can also be provided which are enclosed in the interior of the rotor casing, and which have no connection to an outer surface of the rotor casing.

Appropriately, the stator of the electric machine has a plurality of coil windings which can be formed, for example, of ohmically-conductive materials. Alternatively, the stator windings can also be configured as superconductive windings. Regardless of the type of conductor used, the stator windings can either be fitted as conventional windings, typically on iron teeth, or can be configured as air-gap windings. Air-gap windings of this type are also mounted on retaining structures of the stator which, however, must then be configured of non-magnetic materials.

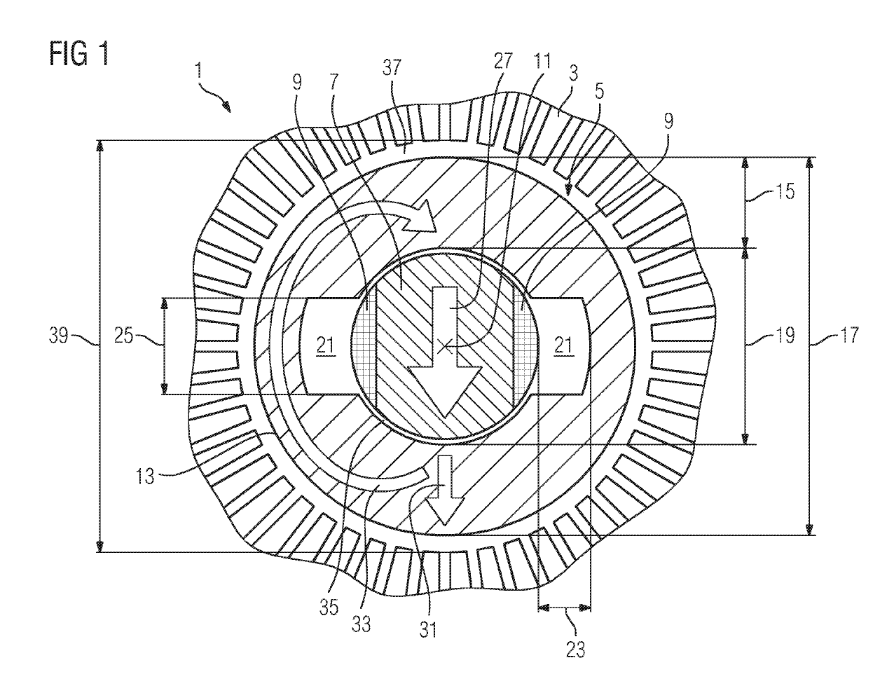

FIG. 1 shows a schematic cross section of an electric machine 1 according to a first exemplary embodiment of the invention. A section of a stator 3 of a hollow cylindrical configuration is shown, with a bore diameter 39, in the interior of which a rotor 5 is arranged. The rotor has an internal rotor core 7, to which an arrangement of, in the present example, a plurality of stacked electric coil windings 9 is secured. These electric coil windings 9 form the excitation winding of the electric machine 1 and, in the exemplary embodiment considered, are configured as superconductive coil windings, in this case based upon a ceramic high-temperature superconductor. In the present example, the function of these windings is the constitution of a two-pole magnetic field, the field characteristic of which within the rotor core is represented by the arrow 11. The two poles of the magnetic field are located here in the upper and lower region of the rotor core 7 represented in FIG. 1. The rotor core 7, with the superconductive coil windings 9 arranged thereupon, thus forms the overall cylindrically-shaped internal rotor. This internal rotor is enclosed by a rotor casing 13, the basic shape of which is a hollow cylinder. Within the plane which lies between the two poles—which runs centrally and horizontally through the illustration in the figure—the hollow body of the rotor casing 13 incorporates two diametrically opposing recesses 21 which, in the present example, are configured as grooves which extend in the axial direction over the length of the rotor casing 13. In the first exemplary embodiment represented, the grooves are open and are not occupied by any other solid body.

Between the internal rotor and the rotor casing 13, in the example represented, a narrow inner gap 35 is arranged, which facilitates the fitting of the internal rotor in the rotor casing 13. This gap is only 1 mm wide, such that the rotor casing is very tightly fitted around the internal rotor. At its two axial end faces, it is mechanically connected to the internal rotor, such that it rotates synchronously with the latter in the interior of the stator 3 around the central axis of rotation 11. Between the rotor casing 13 and the stator 3, an outer gap 37 is provided which, in the present example, is filled with air.

The rotor casing 13 is formed of a soft magnetic material, in the present example a magnetic iron alloy. Its function is the guidance of the two-pole magnetic field generated by the excitation winding 9. The radial flux component, represented in FIG. 1 by the arrow 31, is amplified by the high permeability of the casing material. This radial component 31, in the region of the air gap 37, is also designated as the useful flux. At the site of the stator 3, this radial component 31 progresses further, and there engages in a reciprocal electromagnetic action with other electric coil windings arranged on the stator 3. A rectified flux component, which is analogous to that represented by the arrow 31, is also generated in this case in the upper part of FIG. 1 which, in the interests of clarity, is not represented here.

For the operation of the electric machine, it is advantageous that the largest possible radial magnetic flux component 31 should be generated. It is thus unfavorable, if a magnetic short-circuit path 33 can be formed in the material of the rotor casing 13. In order to reduce this short-circuit component 33 to a minimum, the rotor casing, in the equatorial region between the two poles, is therefore provided with the two opposing recesses 21, which act as non-magnetic interruptions. The depth 23 of the recesses advantageously comprises more than one half of the nominal thickness 15 of the rotor casing, such that the short-circuit component 33 of the magnetic flux is significantly reduced in practice. In the example represented, the width 25 of the recesses is greater than the radial depth 23. In a two-pole machine, the width 25 of the recesses is advantageously approximately equal to the height of the coil windings.

Depending upon the design of the electric machine, the dimensions of the internal rotor and the rotor casing 13 may be of very different magnitudes. It is important that the thickness 15 of the rotor casing 13 should be sufficiently great, such that the external diameter of the internal rotor can be selected to be significantly smaller than the internal diameter 39 of the stator. To this end, the external diameter 17 and the internal diameter 19 of the rotor casing must be clearly different, and can advantageously differ, for example, by at least 20%. In the example represented, with an inner gap 35 between the internal rotor and the rotor casing, the external diameter of the internal rotor is defined as the difference between the internal diameter of the rotor casing and two times the gap width.

Appropriate values for the thickness 15 of the rotor casing 13 are, for example, in excess of 5 cm. As a result, the external diameter of the internal rotor can be reduced by approximately two times this thickness 15, thereby resulting in a significant reduction in centrifugal forces applied to the area of the electric coil windings 9. The dissociating reduction in size ofthe internal rotor, in relation to the internal diameter 39 of the stator 3, thus permits the electric machine 1 to access higher speed ranges. The soft magnetic material of the rotor casing 13 and the embodiment incorporating equatorial recesses 21 also serve to generate a strong magnetic excitation field in the region of the stator, notwithstanding this dissociation.

In the first exemplary embodiment in FIG. 1, the rotor casing 13 is configured as a solid cylindrical metal body with vacuum-tight walls. This rotor casing 13, at the two axial end faces of the rotor 5, is connected to likewise vacuum-tight side panels, which are not represented here, such that the recesses 21 and the inner gap 35 are evacuated. As a result, the entire internal rotor can be maintained at a very low temperature, close to the service temperature of the superconductive coil windings 9, while the rotor casing 13 and its enclosing stator 3 are at a warmer ambient temperature. Where the inner gap 35, as in this case, serves as thermal insulation, it can advantageously be configured to a somewhat greater width than in other embodiments, where it serves only to facilitate the fitting of the rotor casing 13 to the internal rotor. The mechanically rigid connection between the hot rotor casing 13 and the cooled internal rotor can then be appropriately configured of poor thermally-conductive materials.

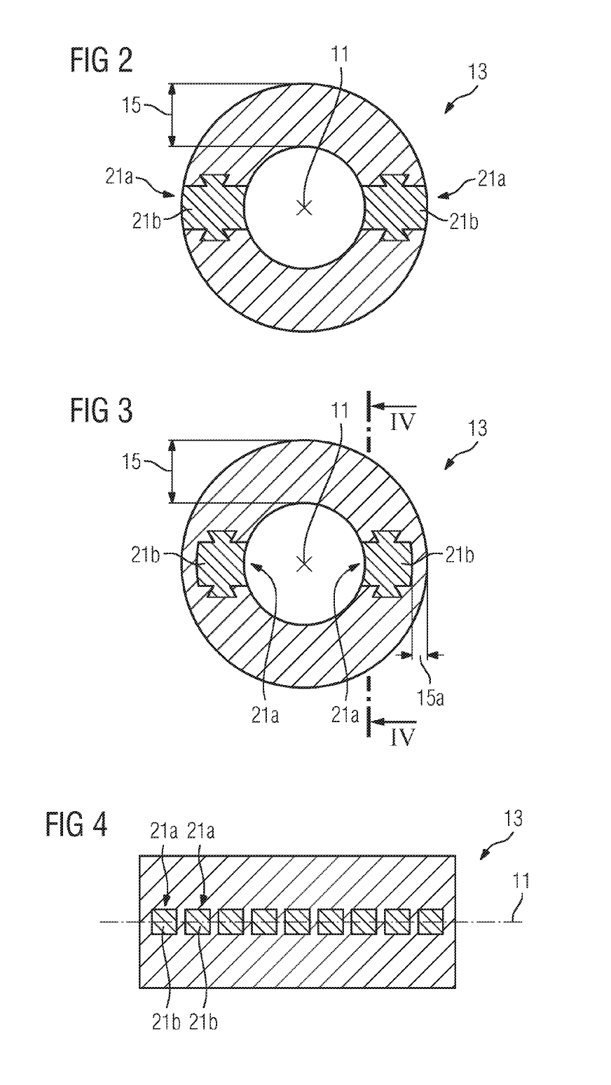

FIG. 2 shows a schematic cross section of a rotor casing 13 according to a second exemplary embodiment of the invention. Analogously to the rotor casing 13 in the first exemplary embodiment, this rotor casing 13 can be used in an electric machine. Here again, two opposing equatorial recesses 21a are formed in the soft magnetic material of the rotor casing 13 which, however, are configured in this example as radially continuous interruptions 21a. Here, each of the interruptions 21a is filled by an infill 21b of a non-magnetic material such that, in combination, the two opposing segments of the soft magnetic material and the two packing pieces arranged between the latter form a closed hollow cylindrical body 13. The interruptions 21a and the infills 21b arranged therein thus extend axially over the full length of the rotor casing 13. By a configuration of this type, with radially and axially continuous but filled recesses, the magnetic short-circuit component 33 in the rotor casing 13 can be particularly strongly suppressed, without significantly compromising the mechanical strength of the rotor casing. In the interests of facilitating the fitting of the rotor casing 13, both the packing pieces 21b and the interruptions 21a can be configured, for example, with mutually matching dovetailed cross-sectional profiles, such that the adjoining segments can be interlocked in the axial direction. Thereafter, the packing pieces 21b can be mechanically connected to the remaining segments of the rotor casing 13, for example by means of retaining rings, front-side screw connections and/or full-penetration pressure rigs with front-side connecting rings. The non-magnetic material of the infills 21b can be, for example, a non-magnetic steel. In its axial end zones, the rotor casing 13 represented in FIG. 2 can also be provided with a secure mechanical connection to an internal rotor arranged in the interior thereof, by means of connecting pieces.

FIG. 3 shows a schematic cross section of a rotor casing according to a third exemplary embodiment of the invention. Here again, two diametrically opposing recesses 21a, each of which is filled by an infill 21b of a non-magnetic material. However, the recesses 21a do not extend over the full radial thickness 15, but a residual thickness 15a remains in the outward-lying region, which is small in relation to the nominal thickness 15 of the rotor casing. Advantageously, this radial thickness 15a is only between 5% and 50% of the nominal thickness 15. Again in this example, the recesses 21a are configured as fully-continuous axial grooves, into which the packing pieces 21b can be inserted. Here again, a configuration with a dovetailed profile is conducive to easy fitting, simultaneously combined with high mechanical strength. Depending upon the remaining residual thickness 15a, the magnetic short-circuit component 33 can also be relatively substantially minimized in this exemplary embodiment. In this case, the smaller the remaining residual thickness 15a, the smaller the short-circuit component 33. An advantage of this configuration, in comparison with the second exemplary embodiment represented in FIG. 2, is superior mechanical strength, as the soft magnetic element of the rotor casing 13 is configured as a continuous component. Moreover, in this embodiment, similarly to the unfilled variant represented in FIG. 1, the rotor casing 13 simultaneously serves as an effective vacuum-tight jacket for the thermal insulation of a cooled internal rotor, conversely to the exemplary embodiment according to FIG. 2, in which this would only be possible by a more complex arrangement for the sealing of the individual components of the rotor casing 13.

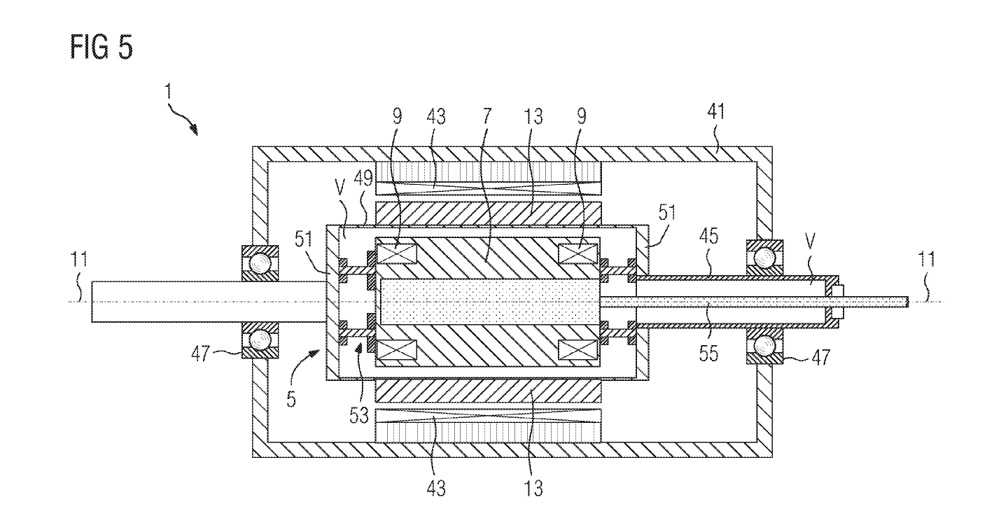

FIG. 4 shows a schematic longitudinal section of a rotor casing 13 according to a fourth exemplary embodiment of the invention. The position of the section corresponds to the sectional plane marked by IV in FIG. 3. However, the recesses 21a can assume various cross-sectional forms, and need not have the cross section shown in FIG. 3. Specifically, the individual recesses 21a can either be configured as radially continuous interruptions or as indentations leaving a residual thickness 15a of the rotor casing. The residual thickness 15a of the rotor casing 13 can here either be left on the inner side or on the outer side of the rotor casing 13, or can be distributed over a number of radial sections. In the fourth exemplary embodiment it is important that, on each side of the rotor casing 13, an arrangement of a plurality of individual recesses is provided, which are mutually axially spaced. For the interruption of the magnetic short-circuit component 33, two such diametrically opposing sets of recesses 21a are again provided here. In the variant shown in FIG. 4, the recesses 21a are provided with packing pieces. Alternatively, the recesses 21a can also be configured as open hollow spaces, for example air-filled or evacuated in combination with their surroundings. Such an arrangement of a plurality of mutually axially spaced recesses can be particularly advantageously provided in a rotor casing 13 which is formed of an axially stacked plurality of soft magnetic plates. A proportion of the plates can then be provided with corresponding voids which, in combination, form the recesses 21a in the plate stack. Continuous axial recesses 21a in a plate stack of this type can also be formed in a similar manner.

FIG. 5 shows a central schematic longitudinal section of an electric machine according to a fifth exemplary embodiment of the invention. A stationary external stator housing 41 is shown, in which the stator windings 43 are arranged on the interior of a hollow cylinder. Within this stator, a rotatably-mounted rotor 5 is fitted to a rotor shaft 45 by means of bearings 47. The rotor comprises a soft magnetic rotor core 7, on which the superconductive coil windings 9 are arranged as the excitation windings of the machine. The internal rotor formed of the rotor core 7 and the coil windings 9 is arranged in an inner vacuum chamber 49, in which a vacuum V is present during the operation of the machine. This vacuum V serves for thermal insulation of the internal rotor, which is maintained overall at a cryogenic temperature level, from its warm environment. The internal rotor is mechanically connected to the rotor shaft 45 by poor thermally conductive connecting elements 53, such that a steep temperature gradient can also be maintained across these connections. The rotor shaft 45 is securely mechanically bonded to the inner vacuum chamber 49 by side elements 51, such that said vacuum chamber rotates synchronously with the rotor shaft 45 and the internal rotor. On the exterior of the vacuum chamber 49, the rotor casing 13 is then arranged, the soft magnetic material of which directs the magnetic field of the excitation windings 9 to the site of the stator windings 43. By means of the fixed bond with the vacuum chamber 49, the rotor casing 13 also rotates synchronously with the other components of the rotor 5. Here again, similarly to the manner described above, the rotor casing 13 is provided with recesses 21, which are arranged between the excitation winding poles. In the fifth exemplary embodiment shown, the internal rotor is cooled by a coolant 55 circulating in the interior of the rotor shaft 45. The entire internal rotor, with the superconductive coil windings 9 and the rotor core 7, is thus cooled to a temperature which is close to the service temperature of the superconductor. The rotor casing 13, conversely, lies outside the thermally-insulating vacuum chamber 49, and is thus maintained at a significantly higher temperature level, which is close to the warm ambient temperature.

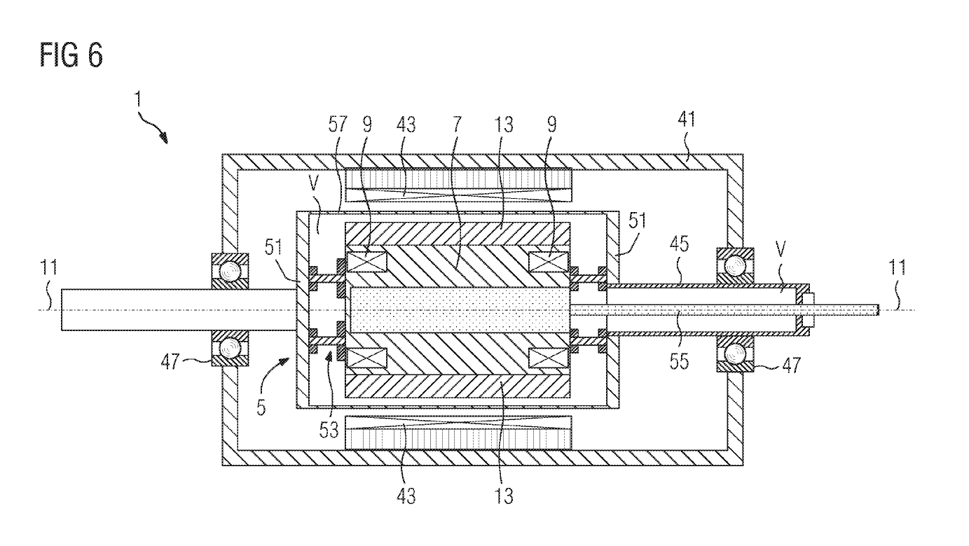

A further alternative exemplary embodiment is schematically represented in FIG. 6. In this sixth exemplary embodiment, the design of the stator is analogous to that in FIG. 5, and the internal rotor components are also similar. However, in this example the rotor casing 13 is fitted directly to the rotor core 7 which carries the excitation winding 9. An outer vacuum chamber 57 is then arranged around the rotor casing 13, which radially encloses the other components of the rotor 5, and forms the outer limit of the rotor. Here again, the vacuum chamber 57 is connected to the rotor shaft 45 by fixed mechanical connecting elements 51, such that the vacuum chamber rotates synchronously with the other elements of the rotor 5. The internal components are thermally insulated from the environment by the internal vacuum V in the chamber 57. Here, conversely to FIG. 5, the rotor casing 13 is arranged inside the vacuum chamber and, together with the rotor core 7 and the excitation windings 9, is cooled to a cold temperature level. In this example, the soft magnetic element of the rotor casing is formed of a cold-resistant magnetic steel. Commonly to both examples in FIG. 5 and FIG. 6, the greater part of the clearance between the inner surface of the stator and the outer surface of the internal rotor, at least in the region of the magnetic poles, is occupied by soft magnetic material of the rotor casing 13. In this regard, it should be emphasized that the dimensional ratio shown in FIGS. 5 and 6 is not true to scale. Rather, in actual electric machines 1, the gaps 35 and 37 are advantageously configured to a significantly smaller thickness than the nominal thickness 15 of the rotor casing 13.

What is claimed is:

1. An electric machine, comprising:
a stator,
a rotor rotatably mounted about an axis of rotation,
at least one electric coil winding arranged in an internal rotor core of the rotor, and
a rotor casing radially enclosing the rotor core and the core winding,
wherein the rotor casing, around at least a majority of the circumference of the external rotor casing, is composed of a soft magnetic material.

2. The electric machine of claim 1, wherein the rotor casing, around at least a majority of the circumference of the rotor casing, has a thickness of at least 1 cm.

3. The electric machine of claim 1, wherein the rotor casing has a regular cylindrical hollow body having an external diameter at least 10% greater than an internal diameter of the hollow body.

4. The electric machine of claim 1, wherein the at least one electric coil winding of the rotor comprises a superconductive coil winding.

5. The electric machine of claim 1, wherein the soft magnetic material of the rotor casing has a relative magnetic permeability of at least 30.

6. The electric machine of claim 1, wherein the rotor casing includes at least one pair of diametrically opposing recesses.

7. The electric machine of claim 6, wherein the recesses are formed in the soft magnetic material of the rotor casing, and wherein the recesses are at least partially filled with a non-magnetic material.

8. The electric machine of claim 6, wherein the rotor casing comprises two diametrically opposing arrangements, each including a plurality of axially spaced recesses.

9. The electric machine of claim 6, wherein the rotor casing comprises at least two diametrically opposing and radially continuous interruptions.

10. The electric machine of claim 6, wherein:
the coil winding comprises a pole pair number n,
the rotor casing has at least n pairs of respectively diametrically opposing recesses, and
each recess in the circumferential direction is arranged between adjoining poles.

11. The electric machine of claim 1, wherein an inner gap is defined between the rotor core, and the rotor casing.

12. The electric machine of claim 1, wherein the rotor casing encloses the rotor core and the at least one electric coil winding in a vacuum-tight manner.

13. The electric machine of claim 1, wherein an inner vacuum chamber is defined between (a) the rotor core and at least one electric coil winding and (b) the rotor casing,
wherein the inner vacuum chamber encloses the rotor core and the at least one electric coil winding in a vacuum-tight manner.

14. The electric machine of claim 1, wherein the rotor casing is enclosed by an outer vacuum chamber.

15. The electric machine of claim 1, wherein the electric coil winding is secured on the rotor core by at least one fixing strap formed from a poor thermally-conductive material.
